(19) United States
(12) Patent Application Publication
(10) Pub. No.: US 2005/0163967 A1
(43) Pub. Date: Jul. 28, 2005

(54) Apertured film with raised profile elements method for making the same, and the products thereof

(75) Inventors: John Steffen, Sugar Hill, GA (US); Timothy Huskey, Cumming, GA (US)

Correspondence Address: WOOD, PHILLIPS, KATZ, CLARK & MORTIMER, 500 W. MADISON STREET, SUITE 3800, CHICAGO, IL, 60661, US

(73) Assignee: Polymer Group, Inc.

(21) Appl. No.: 10/798,041

(22) Filed: Mar. 11, 2004

Related U.S. Application Data
(60) Provisional application No. 60/540,227, filed on Jan. 28, 2004.

(51) Int. Cl. B32B 3/10

(52) U.S. Cl. 428/138

(57) ABSTRACT

The present invention generally relates to an apertured or reticulated film, and more specifically, the present invention relates to a method of imparting one or more raised elements into a previously apertured or reticulated film utilizing a forming surface. A forming apparatus can accept an apertured film, preferably but not limited to a thermoplastic composition, and impart one or more raised continuous or discontinuous profiled elements into the surface of the apertured film by exposing the apertured film to an air stream having an elevated temperature (such as by exposure of the air stream to direct contact with a heating element). The heated air stream affects the apertured film by inducing the film to deflect onto profiled elements defined in the forming surface of the forming apparatus.

### TECHNICAL FIELD

The present invention generally relates to an apertured or reticulated film, and more specifically, the present invention relates to a method of imparting one or more respective profiled elements into a previously apertured film utilizing a forming apparatus comprised of profiled elements, a heat source, and source of motive force.

### BACKGROUND OF THE INVENTION

Films are used in a wide variety of applications where the engineered qualities of the apertured and/or unapertured film can be advantageously employed as a component substrate. The use of selected thermoplastic polymers in the construction of film products, selected treatment of the polymeric films (either while in melt form or in an integrated structure), and selected use of various mechanisms by which the film is integrated into a useful construct, are typical variables by which to adjust and alter the performance of the resultant polymeric film product.

The formation of finite thickness films from thermoplastic polymers is a well known practice. Thermoplastic polymer films can be formed by either dispersion of a quantity of molten polymer into a mold having the dimensions of the desired end product, known as a thermo-formed or injection-molded film, or by continuously forcing the molten polymer through a die, known as an extruded film. Extruded thermoplastic polymer films can either be formed such that the film is cooled then wound as a completed product, or dispensed directly onto a substrate material to form a composite material having performance of both the substrate and the film layers. Examples of suitable substrate materials include other films, polymeric or metallic sheet stock and woven or nonwoven fabrics.

The application of the extruded film directly onto a substrate material imparts the substrate material with enhanced physical properties. It is known in the art that the application of a thermoplastic polymer film having suitable flexibility and porosity onto a nonwoven fabric results in a composite material having significant barrier properties and is suitable for disposable protective garment manufacture.

To further improve the performance of the thermoplastic polymer film when used in composite material manufacture, various additives are admixed with the thermoplastic polymer prior to or during extrusion. Typical additives employed are those selected from various colorants or opacifiers, such as titanium dioxide. Water insoluble salts such as calcium carbonate may be added to the polymer mix resulting in a film that can be rendered micro-porous by the application of draft tension, as taught by U.S. Pat. No. 5,910,225 to McAmish. If there is a desire to form a composite wherein the thermoplastic polymer film will be exposed to a transitory temperature above the melting temperature of the polymer, antioxidants can be incorporated into the mix to aid in reducing thermal degradation. In the event where the family of thermoplastic polymers to be used in the extruded film exhibits a dissimilar characteristic such as surface energy from the thermoplastic polymer of the substrate material, compatibilizers are incorporated into the polymer mix.

Film substrates are desirable for a variety of end-use applications due to the barrier performance such substrates can provide. Films have proven to be particularly suitable for a variety of medical, hygiene, and industrial applications and when utilized in a laminate construct, permits cost-effective, disposable use. Use of such materials for sanitary napkins, medical wipes, and the like has become increasingly widespread, since the use of a nonwoven fabric constructs can provide a desired softness that may be required for specific medical and hygiene applications.

In certain end-use applications it is advantageous to impart an aesthetic quality into a film substrate by way of aperturing and/or embossing the film. Typically, apertured films are utilized in feminine hygiene or medical products and may consist of microporous films, as taught in U.S. Pat. No. 6,264,864, or reticulated films, as described in U.S. Pat. No. 4,381,326 to Kelly, both of which are hereby incorporated by reference. The use of vacuum systems to emboss a film substrate is known in the art. For instance, U.S. H1927 to Chen, et al., hereby incorporated by reference, discloses a method for embossing a film on a screen, wherein a vacuum pulls he film into the screen to impart a pattern. However, a reticulated film substrate would be less affected by such a method due the ability of the air to pass through the substrate. Other attempts have been made to emboss and aperture film utilizing a perforated screen and vacuum; however the force of the vacuum pull that subsequently apertures the film leaves an unfinished edge about the perimeter of the aperture on the backside of the film.

An unmet need remains for an apertured or reticulated film comprising one or more well pronounced, well defined profiled elements for end-use applications including, but not limited to, sanitary napkins, panty liners, as well as surgical drapes and bed pads.

### SUMMARY OF THE INVENTION

The present invention generally relates to an apertured or reticulated film, and more specifically, the present invention relates to a method of imparting one or more raised elements into a previously apertured or reticulated film utilizing a forming surface.

A forming apparatus can accept an apertured film, preferably but not limited to a thermoplastic composition, and impart one or more raised continuous or discontinuous profiled elements into the surface of the apertured film by exposing the apertured film to an air stream having an elevated temperature (such as by exposure of the air stream to direct contact with a heating element). The heated air stream affects the apertured film by inducing the film to deflect onto profiled elements defined in the forming surface of the forming apparatus.

A source of motive force is applied to an opposite face of the forming surface to assist the process by applying incremental motive force to the elevated temperature apertured film, via one or more vents transverse to the surface of the profiled elements of the forming surface. A suitable source of motive force may include a vacuum. Optionally, a motive force may be applied to the forming surface itself. Upon application of suitable ambient or active cooling, the resulting apertured film substrate is durably imparted with the respective profiles in negative orientation of the one or more profiled elements positioned within the forming apparatus.

In another embodiment, the apertured film of the invention is bonded to one or more additional substrates to form a laminate structure. A variety of substrates may be mechanically or chemically bonded to the film include filamentary webs, such as spunbond or meltblown webs, carded webs, such as through air bond or thermal bond webs, films, such as monolithic film, and a combination thereof.

Other features and advantages of the present invention will become readily apparent from the following detailed description, the accompanying drawings, and the appended claims.

### BRIEF DESCRIPTION OF THE DRAWINGS

FIG. 1 is a schematic view of the equipment for making a reticulated film suitable for embossing on an laminar air controlled embossing surface;

FIG. 2 is a view in perspective of the reticulated sheet material produced in accordance with the invention;

FIG. 3 is an exemplary forming surface of a forming apparatus of the invention;

FIG. 4 is a photomicrograph of a reticulated film;

FIG. 5 is an enlarged photomicrograph of a reticulated film in FIG. 4;

FIG. 6 is an imaged reticulated film in accordance with the present invention;

FIG. 7 is an enlarged view of an imaged reticulated film in accordance with the present invention;

FIG. 8 is an imaged reticulated film in accordance with the present invention;

FIG. 9 is an enlarged view of the reticulated film shown in FIG. 8; and

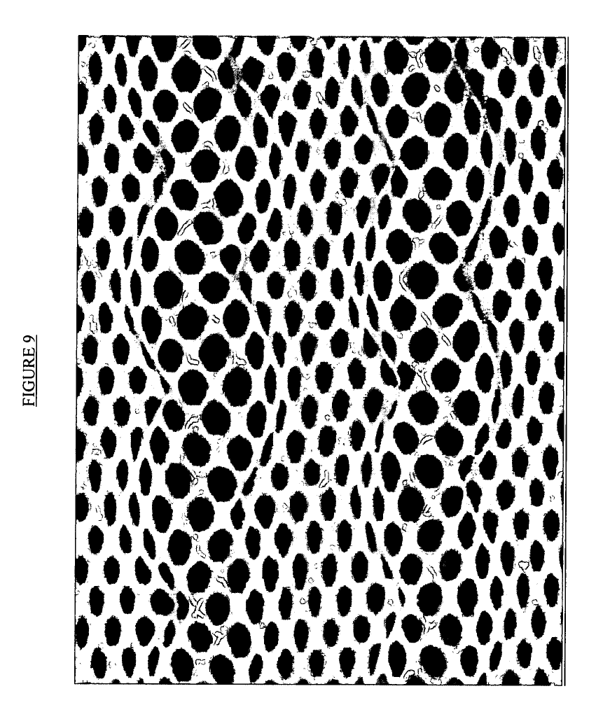

FIG. 10 is a graph illustrating rewet performance of tested samples.

### DETAILED DESCRIPTION

While the present invention is susceptible of embodiment in various forms, there is shown in the drawings and will hereinafter be described a presently preferred embodiment of the invention, with the understanding that the present disclosure is to be considered as an exemplification of the invention, and is not intended to limit the invention to the specific embodiment illustrated.

In accordance with the present invention, an apertured film, such as a reticulated film, is imparted with one or more pronounced profiled elements as defined by the profiled surface of a forming apparatus. Typically, a reticulated film is produced by a conventional extrusion apparatus (described below). One such method is to form a apertured sheet directly from the extruded film without collecting the film as an intermediate product. This can be done by the process which is schematically illustrated in the drawings.

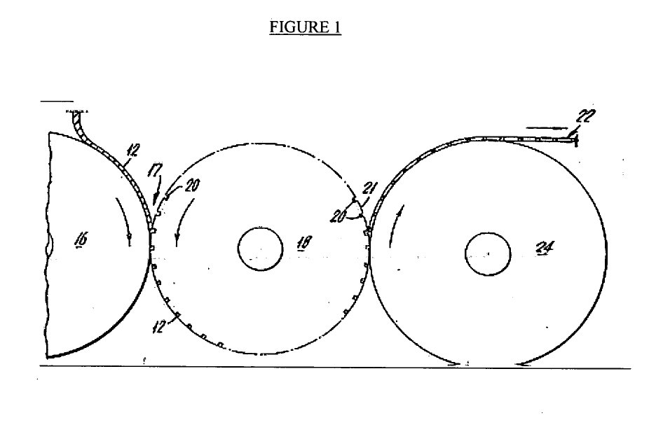

Referring to the drawings, FIG. 1 illustrates an olefin polymer extruded in the form of a thin sheet 12 of molten material through a conventional slot die 14. The still molten sheet 12 is collected on a heated rotating roll 16 having a smooth surface. The heated smooth roll 16 has a predetermined peripheral speed. The temperature of the heated smooth roll 16 is such that the sheet 12 is molten and formable when the sheet 12 reaches the nip 17 between the roll 16 and a second roll 18. The second (embossing) roll 18 is in contact with the smooth roll 16 at the said nip 17 between the two rolls. The embossing roll 18 is cooled, and has a resilient engraved surface. The engraving is in the form of continuous recessed areas 20 surrounding discontinuous raised areas 21. For instance, a preferred engraved pattern has a first series of grooves running circumferentially around the surface of the embossing roll 18, and a second series of grooves running perpendicular to and intersecting the first series of grooves. The said second series of grooves are parallel to the longitudinal axis of the embossing roll 18. They are shown in cross-section and exaggerated form as 20 in the drawings.

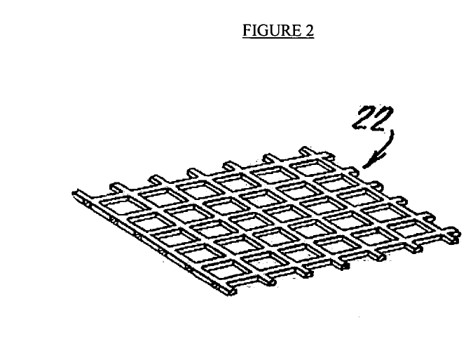

The sheet 12 transfers from the smooth roll 16 to the embossing roll 18 at the nip 17 between the two rolls. The embossing roll 18 is cooled so that the thermoplastic rubber solidifies while it is in contact therewith. The embossing roll 18 preferably is rotating at a slightly higher peripheral speed than the smooth roll 16. In some cases, the two rolls 16, 18 can rotate at the same speed, and in others, the embossing roll 18 can be slightly slower than the smooth roll 16. There is a wiping action at the nip 17 which forces substantially all of the molten sheet 12 into the grooves 20. The sheet begins to solidify in the form of a netting or reticulated sheet 22 while it is in contact with the embossing roll 18. The netting will have the same structure or pattern as the engraved grooves on the roll 18. A typical reticulated sheet product 22 is illustrated in FIG. 2.

The reticulated sheet product may be collected and wound as a rolled good and transferred onto a forming apparatus or directly advanced onto forming apparatus. In accordance with the present invention, an apertured film, which is meant to include a reticulated film, microporous film or otherwise perforated film, is advanced onto a forming apparatus. The forming surface may be comprised of suitable matrix, and/or coated with a suitable matrix, which is thermally incompatible with the composition of the apertured film. Suitable compositions include thermoplastics, metal, rubber, glass, or a combination thereof. Further, the forming apparatus may be a profiled continuous surface, a plurality of linked profiled plates, and the combinations thereof. Further still, the forming surface may be circular in formation (i.e. drum-like), as well as planar, and follow a pre-determined continuous path.

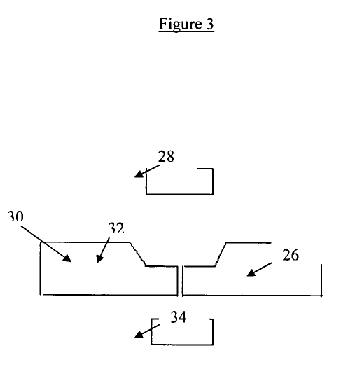

An exemplary forming apparatus, partially shown in FIG. 3, can accept an apertured film, preferably but not limited to a thermoplastic composition. Exemplary compounds include those polymers chosen from the group of thermoplastic polymers consisting of polyolefins, polyamides, and polyesters, wherein the polyolefins are chosen from the group consisting of polypropylene, polyethylene, and the combination and modifications thereof. The film is advanced onto the forming apparatus 26 wherein one or more raised continuous or discontinuous profiled elements is imparted into the surface of the apertured film by exposing the apertured film to a heat source 28, preferably an air stream having an elevated temperature (such as by exposure of the air stream to direct contact with a heating element), whereby the air stream heats the apertured film to a temperature less than the melting temperature of said film so as to soften the film. Other suitable heat sources include IR, heated rolls, and heat forming surfaces. The heat source 28 affects the apertured film by inducing the film to deflect onto profiled elements 30 defined in the forming surface of the forming apparatus 26.

A motive force 34 positioned opposite the face of the forming surface assists the process by applying incremental motive force to the elevated temperature apertured film, via one or more vents 32 transverse to the surface of the profiled elements of the forming surface. Upon application of suitable ambient or active cooling, the resulting apertured film substrate is durably imparted with the respective profiles in negative orientation of the one or more profiled elements positioned within the forming apparatus.

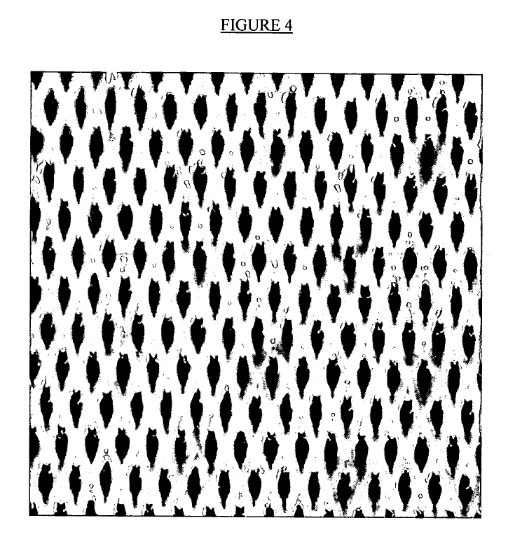

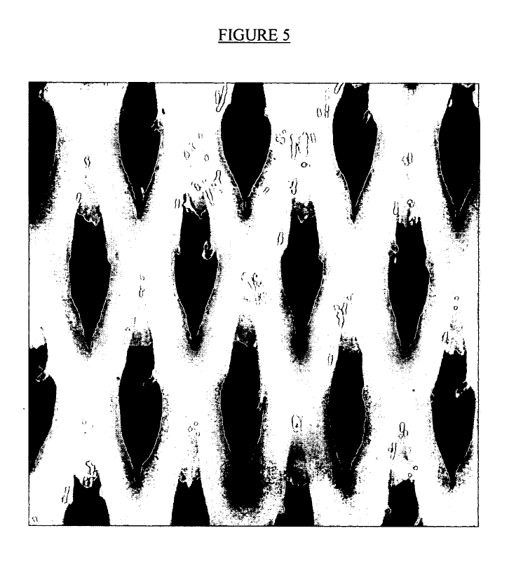

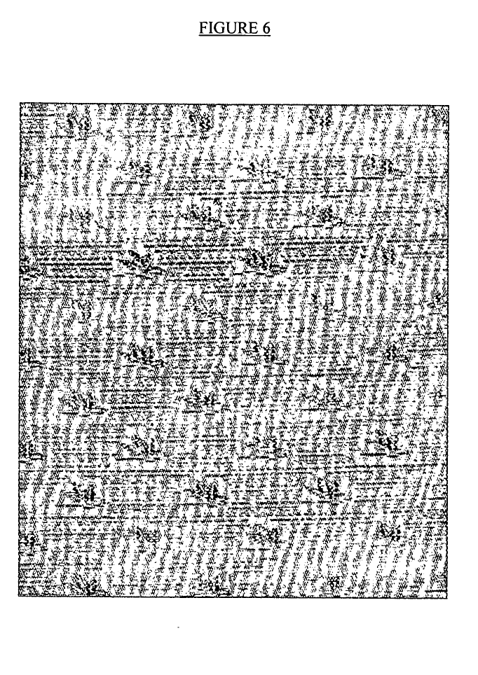

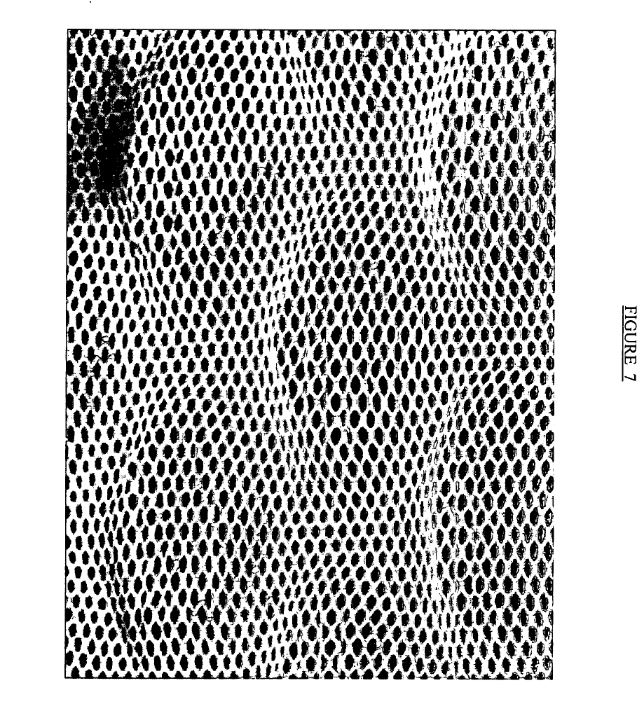

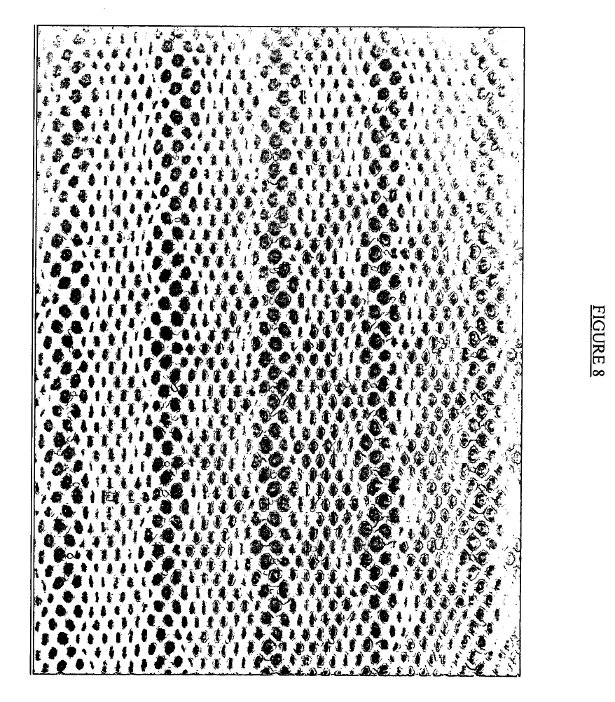

FIGS. 4 and 5 are photomicrographs of an apertured film prior to being affected by a forming apparatus. FIGS. 6 through 8 are examples of an apertured film made in accordance with the present invention.

In addition, the film of the present invention may be mechanically or chemically bonded to one or more substrates to form a laminate structure. Suitable substrates include continuous filament substrates. In general, the formation of continuous filament webs involves the practice of the “spunbond” process. A spunbond process involves supplying a molten polymer, which is then extruded under pressure through a large number of orifices in a plate known as a spinneret or die. The resulting continuous filaments are quenched and drawn by any of a number of methods, such as slot draw systems, attenuator guns, or Godet rolls. The continuous filaments are collected as a loose web upon a moving foraminous surface, such as a wire mesh conveyor belt. When more than one spinneret is used in line for the purpose of forming a multi-layered fabric, the subsequent webs are collected upon the uppermost surface of the previously formed web. Further, the addition of a continuous filament fabric may include those fabrics formed from filaments having a nano-denier, as taught in U.S. Pat. Nos. 5,678,379 and 6,114,017, both incorporated herein by reference. Further still, the continuous filament fabric may be formed from an intermingling of conventional and nano-denier filaments.

Further, a meltblown layer may be utilized in a laminate structure. The meltblown process is a related means to the spunbond process for forming a layer of a nonwoven fabric is the meltblown process. Again, a molten polymer is extruded under pressure through orifices in a spinneret or die. High velocity air impinges upon and entrains the filaments as they exit the die. The energy of this step is such that the formed filaments are greatly reduced in diameter and are fractured so that microfibers of finite length are produced. This differs from the spunbond process whereby the continuity of the filaments is preserved. The process to form either a single layer or a multiple-layer fabric is continuous, that is, the process steps are uninterrupted from extrusion of the filaments to form the first layer until the bonded web is wound into a roll. Methods for producing these types of fabrics are described in U.S. Pat. No. 4,041,203. The meltblown process, as well as the cross-sectional profile of the meltblown microfiber, is not a critical limitation to the practice of the present invention. Further, the addition of a continuous filament fabric may include those fabrics formed from filaments having a nano-denier, as taught in U.S. Pat. Nos. 5,678,379 and 6,114,017, both incorporated herein by reference. Further still, the continuous filament fabric may be formed from an intermingling of conventional and nano-denier filaments.

Various films may also be laminated to the film of the present invention, such as monolithic films, as taught in U.S. Pat. No. 6,191,211, hereby incorporated by reference, as well as carded webs. Performance and/or aesthetic enhancing additives may be incorporated into or topically applied to the film of the invention, as well as within one or more layers of a laminate structure. Suitable additives include, but are not limited to pigments, fragrances, hydrophilic chemistries, emollients, and other additives that benefit the wellness of the skin.

Such additives may be applied topically by one or more methods known in the art, including submerging, padding, kiss coatings, or spraying.

The film of the present invention is suitable for a variety of medical, industrial, and hygiene end-use applications. The apertured film comprised of one or profiled elements are particularly useful as an absorbent article component, such as a cover layer, transfer layer, or other medially located layer. The depth imparted into the film by the incorporation of the profiled elements provides increased separation between the skin and the absorbent core. Further, the film of the present invention has an improved fluid handling and caliper performance, allowing for human exudates to quickly enter the absorbent core. The increased separation between the skin and the absorbent core also helps prevent liquids from rewetting the surface of the cover layer.

Samples A through D were made in accordance with the present invention. The strikethrough and rewet performance of the film is shown in Table 1. The samples in Table 1 where tested for strikethrough and rewet according to the following test method:
Cut three 50 mm×115 mm pieces of airlaid nonwoven for use as core
Cut and weigh one 45 mm×100 mm blotter paper for absorbent
Center airlaid core over a piece of 75 mm×250 mm plexiglass
Place film sample over core
Affix film sample to plexiglass on top and bottom
Place strikethrough template over film
Measure 6 ml of synthetic test fluid and pour onto film—start stopwatch
Record time after fluid drains well into the core
Remove strikethrough template
Place 45 mm×100 mm pre-weighed blotter paper on film
Place 800 gram weight on film for 1 minute
Remove weight and weigh paper.
Subtract dry weight from wet weight

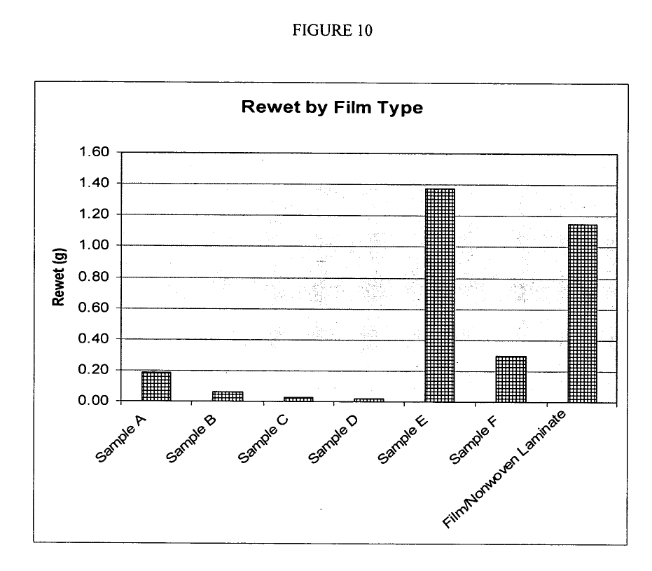

As per the aforementioned test method, Samples A through D have a superior rewet performance compared to Samples E and F. Sample E is a reticulated film lacking the raised profiled elements which are imparted in Samples A through D, while Sample F is an air apertured film, also lacking raised profiled elements. The graph of FIG. 10 illustrates the rewet performances for each sample tested in accordance with the disclosed method.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

TABLE 1

| | Thickness | Open Area | Strikethrough | Rewet | Smoothness | Gloss |
|---|---|---|---|---|---|---|
| Film Type | [micron] | [%] | [secs] | [g] | [mV-Kaw] | [Units] |
| Sample A | 511 | 41.4 | 1.5 | 0.19 | 6.1 | 2.6 |
| Sample B | 710 | 38.3 | 1.1 | 0.06 | 8.1 | 6 |
| Sample C | 726 | 38.0 | 1.4 | 0.03 | 6.3 | 6.2 |
| Sample D | 576 | 40.8 | 1.2 | 0.02 | 10.4 | 4.1 |
| Sample E | 206 | 30.2 | 1.3 | 1.38 | 2.8 | 3 |
| Sample F | 350 | 17.5 | 1.7 | 0.30 | 3 | NM |
| Film/Nonwoven | 506 | 15.5 | 1.7 | 1.15 | 3.6 | 14.8 |
| Laminate Sample | | | | | | |

1. A method of making an apertured film comprising one or more profiled elements comprising the steps of:
a. providing a apertured film;
b. providing a forming apparatus with a surface comprised of one or more profiled elements;
c. providing a heat source;
d. providing a motive force;
e. advancing said apertured film onto said forming apparatus; and
f. heating said film with said heat source to a temperature less than the melting temperature of said film, wherein said heat affects said film by inducing said film to deflect onto profiled elements defined by said forming surface of said forming apparatus, while said motive force applies incremental force to assist deflection of said apertured film.

2. A method of making an apertured film comprising one or more profiled elements as in claim 1, wherein said apertured film is a reticulated film.

3. A method of making an apertured film comprising one or more profiled elements as in claim 1, wherein said motive force is a vacuum.

4. A method of making an apertured film comprising one or more profiled elements as in claim 1, wherein said film is a laminate component.

5. A method of making an apertured film comprising one or more profiled elements as in claim 1, wherein said heat source is an air stream.

6. A method of making an apertured film comprising one or more profiled elements as in claim 1, wherein said film is an absorbent article component.

7. A method of making an apertured film comprising one or more profiled elements as in claim 1, wherein said film is a surgical drape component.

8. A method of making an apertured film comprising one or more profiled elements as in claim 1, wherein said film is a bed pad component.

9. A method of making an apertured film comprising one or more profiled elements as in claim 1, wherein said film incorporates one or more melt additives.

10. A method of making an apertured film comprising one or more profiled elements as in claim 1, wherein said film has one or more additives topically applied.

11. An apertured film comprising one or more profiled elements, wherein said film is affected by a heat source and incremental force while positioned upon a forming apparatus so as to impart one or more profiled elements into said apertured film.

12. An apertured film as in claim 11, wherein said film comprises a cover for an absorbent article.

13. A cover layer as in claim 10, wherein said cover layer comprises at least one performance additive.

14. An absorbent article comprising;
a. a liquid permeable cover layer, wherein said cover layer comprises an apertured film having one or more profiled elements;
b. a liquid impermeable backsheet; and
c. an absorbent core position between said liquid permeable imaged apertured cover layer and said liquid impermeable backsheet.
